(19) United States
(12) Patent Application Publication
(10) Pub. No.: US 2006/0039852 A1
(43) Pub. Date: Feb. 23, 2006

(54) Method for making lead oxide for lead-acid batteries

(75) Inventors: Glenn M. Trischan, Brown Deer, WI (US); Richard R. Binder, Menomonee Falls, WI (US); Michele Sick, Bear, DE (US); Christian P. Hansen, Eagle, WI (US); David A. Wynn, Glendale, WI (US); Thomas K. Brossman, Smyrna, DE (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 10/921,763

(22) Filed: Aug. 19, 2004

(51) Int. Cl. C01G 21/02

(52) U.S. Cl. 423/619

(57) ABSTRACT

A method of producing lead oxide for use with lead-acid batteries includes providing a material comprising lead and adding calcium to the material at a level between approximately 100 and 400 ppm to form a lead-calcium alloy. The method further includes oxidizing the lead-calcium alloy to form lead oxide.

### BACKGROUND

The present invention relates generally to the field of batteries (e.g., lead-acid batteries for use in starting, lighting, and ignition (“SLI”) applications, etc.) and manufacturing methods for such batteries and components thereof. More specifically, the present invention relates to lead oxide for use with such batteries and methods for producing such lead oxide.

Lead-acid batteries include electrically conductive positive and negative electrodes that are made of lead or a lead alloy (e.g., lead-calcium alloys). The electrodes may be provided in the battery as plates or grids that have a generally planar configuration or may be provided as electrodes that are wound in a spiral (as shown, for example, in U.S. Pat. No. 5,871,862).

At least a portion of the positive electrodes have a material (e.g., a paste) applied thereto that is made by mixing lead oxide with water, acid (e.g., sulfuric acid), and any of a variety of additive materials. The positive electrodes including the applied paste are then cured or dried to remove excess liquid in the paste and are assembled into a battery (e.g., positive and negative plates are provided with a separator between them in a battery container, after which an electrolyte such as acid (e.g., sulfuric acid) is introduced into the battery).

One method that has been utilized to produce the lead oxide used in preparing the paste is a Barton process, in which molten lead and oxygen are reacted to form lead oxide in a Barton pot. Once the lead oxide particles reaches an appropriate aerodynamic size, the particles are ejected from the Barton pot. Another method involves the use of a mill (e.g., a ball mill) in which lead particles are reacted with oxygen such that the surface of the lead particles become oxidized.

In recent years, silver has been used as an alloy element in the manufacture of lead alloy battery electrodes to reduce the rate at which the battery electrodes corrode and/or to improve various mechanical properties of the electrodes. Because batteries are recycled at the end of their useful life, some of the alloy components used to form the battery electrodes may be included in recycled lead that is later used in the production of lead oxide for use in producing battery paste. With an increasing tendency to use silver in the lead electrodes of batteries (and in other components of the batteries, such as battery terminals), and because of the difficulty in removing the silver from the recycled lead, therefore, the silver content of the recycled lead has also been increasing.

One difficulty with the increased tendency of recycled lead to include silver impurities is that silver may have an adverse effect on the production of lead oxide for use in preparing battery paste. For example, silver may decrease the rate of oxidation of lead, which in turn reduces the production rate for lead oxide for use in forming battery paste.

Antimony has been used in an attempt to compensate for the silver present in recycled lead. For example, antimony may be added to the lead used to form the lead oxide used in making battery paste in an amount similar to the silver content of the lead. As the silver content in the recycled lead increases, however, additional antimony must also be added. Antimony, however, may contribute to increased gassing of lead-acid batteries. Further, the effectiveness of antimony to compensate for the increased silver content may decrease with increasing amounts of antimony and silver.

There is thus a need to provide an improved method for producing lead oxide for use in producing paste for use with lead-acid batteries. Those of skill in the art will understand that these and other needs may be met by one or more of the exemplary embodiments described herein.

### SUMMARY

The present invention relates to a method of producing lead oxide for use with lead-acid batteries that includes providing a material comprising lead and adding calcium to the material at a level between approximately 100 and 400 ppm to form a lead-calcium alloy. The method further includes oxidizing the lead-calcium alloy to form lead oxide.

The present invention also relates to a method for making lead oxide for use in lead-acid battery active material that includes oxidizing a material comprising lead, calcium, and silver to form lead oxide. The calcium is present in the material in an amount between approximately 100 and 400 ppm.

The present invention further relates to a method for preparing electrodes for use in a lead-acid battery that includes preparing a material comprising lead and between approximately 100 and 400 ppm calcium and oxidizing the material to form lead oxide. The method also includes mixing the oxidized material with water and acid to produce a paste.

The present invention further relates to a method of enhancing the oxidation of lead during production of lead-acid batteries that includes alloying between about 100 and 400 ppm calcium with the lead and subjecting the resulting alloy to oxidizing conditions

The present invention further relates to a method of oxidizing lead used in production of lead-acid batteries. An improvement includes effecting oxidation after alloying between approximately 100 and 400 ppm calcium into the lead.

The present invention further relates to a method of producing lead oxide from lead alloys containing silver for use in a lead acid battery electrode. The method includes alloying calcium into the silver-containing lead and subjecting the resultant alloy to oxidizing conditions.

### DETAILED DESCRIPTION OF EXEMPLARY EMBODIMENTS

According to an exemplary embodiment, lead oxide is produced by reacting lead or a lead alloy (hereinafter referred to as “lead” for simplicity) with oxygen. Calcium is added to the lead and is intended to increase the rate of oxidation of the lead and to compensate for the effects that result from the inclusion of impurity elements (e.g., silver) in the lead.

It is also intended that the use of calcium will reduce or eliminate the need to utilize antimony in the lead oxide manufacturing process to reduce the effects of variable impurity concentrations. One potential benefit of reducing or eliminating the use of antimony is that gassing (e.g., during charge cycling of the battery) in the finished lead-acid battery may be reduced. Utilizing calcium in place of antimony may also advantageously allow for compensation for a wider range of oxidation-retarding impurities (e.g., silver) that may be included in the lead alloy used to form the lead oxide, and may also allow the achievement of higher and more uniform oxidation rates when variable impurity concentrations are present.

The lead used in the production of the lead oxide may be derived from a primary source (e.g., mines, electrolytic refining, etc.), a secondary source (e.g., recycled lead from spent batteries, etc.), or combinations thereof. The lead may include various impurity elements included therein, such as, but not limited to, bismuth, silver, sulfur, tin, and iron. According to an exemplary embodiment, the lead includes lead obtained from a secondary source (e.g., recycled battery electrodes) and includes silver in an amount between approximately 1 and 100 parts per million (ppm) (e.g., approximately 50 ppm).

The concentration levels of the various impurities included in the lead may vary according to various exemplary embodiments. According to one exemplary embodiment, the lead may have an impurity composition such as that shown below in Table 1. Lead comprising a relatively large proportion of primary (e.g., non-recycled) lead may have concentration levels toward the lower end of the ranges shown in Table 1, while lead comprising a relatively large proportion of secondary lead may have concentration levels anywhere within such ranges. According to other exemplary embodiments, different impurity levels and/or different impurity elements may be present in the lead.

TABLE 1

| Impurity Element | Concentration (ppm) |
|---|---|
| Antimony (Sb) | 1-10 |
| Astatine (As) | <1 |
| Calcium (Ca) | <2 |
| Cadmium (Cd) | 1-10 |
| Copper (Cu) | 1-20 |
| Nickel (Ni) | 1-5 |
| Silver (Ag) | 1-60 |
| Sulfur (S) | 1-20 |
| Tellurium (Te) | 0.1-3 |
| Tin (Sn) | 1-10 |
| Zinc (Zn) | <5 |
| Aluminum (Al) | <4 |
| Barium (Ba) | <1 |
| Bismuth (Bi) | 5-150 |
| Cobalt (Co) | <1 |
| Chromium (Cr) | <1 |
| Iron (Fe) | 1-10 |
| Manganese (Mn) | <0.1 |
| Selenium (Se) | 0.5-5 |
| Thallium (Tl) | 1-20 |
| Platinum (Pt) | <1 |

According to an exemplary embodiment, calcium is added to the lead such that calcium is present in the lead at a concentration level of between approximately 100 and 400 ppm (e.g., between approximately 100 and 200 ppm, approximately 150 ppm, etc.). For example, according to an exemplary embodiment, the calcium may be provided in an amount that is approximately 3.0 to 3.5 times the amount of silver provided in the lead. According to an exemplary embodiment, the calcium is provided in a form that may be oxidized (e.g., metallic calcium or an intermetallic calcium-lead alloy).

According to an exemplary embodiment, to obtain lead having approximately 150 ppm calcium, a 30 pound ingot or block of material comprising approximately 1 atomic percent calcium (with the balance being lead) may be added to approximately 2,000 pounds of molten lead. The molten lead and/or the lead in the ingot containing calcium may include various impurity elements, as described previously.

Various other methods may be used to obtain lead having between approximately 100 and 400 ppm calcium, as those of skill in the art will appreciate. For example, calcium may be added to the lead without being incorporated in a lead-containing ingot. Further, the calcium may be added to the lead by a lead smelter (i.e., as an alloying element with the lead to eliminate the necessity of a separate calcium addition step) or may be added after the lead is received from the smelter but prior to the lead oxide production process. One advantageous feature of having the calcium added as an alloy element by the lead smelter is that better overall uniformity of the lead may be obtained.

According to an exemplary embodiment, the molten lead having between approximately 100 and 400 ppm calcium is introduced into a Barton pot, where the molten lead is reacted with oxygen to produce lead oxide particles. For example, according to an exemplary embodiment, the lead oxide particles may be produced in a Barton pot that has a temperature of between approximately 800° and 900° F. and an air temperature of between approximately 550° and 800° F. The lead oxide may then be utilized to form a paste that may act as active material when pasted onto an electrode (e.g., a positive electrode) for a lead-acid battery.

One advantageous feature of utilizing calcium in an amount between approximately 100 and 400 ppm in the lead is that the oxidation rate of the lead may be increased. For example, as compared to lead having antimony added thereto in an amount between approximately 20 and 40 ppm, lead having calcium added thereto in an amount between approximately 100 and 400 ppm may result in between a 10 and 12 percent increase in the rate of lead oxide production.

Lead oxide produced using lead having calcium added thereto as described above may be used in any pasted lead-acid battery product, including flooded lead-acid batteries, absorptive glass mat (AGM) flat plate batteries, or spiral wound (e.g., AGM) batteries.

Lead oxide formed as described above may be used to produce battery paste for use as an active material on lead-acid battery electrodes. For example, the lead oxide may be mixed with water, acid (e.g., sulfuric acid), and additives may be mixed together to form a paste, which may then be applied to (e.g., pasted on) battery grids and cured to form lead sulfates for use in charging/discharging reactions in lead-acid batteries.

It should be noted that calcium may be used as an addition to the lead alloy used to form lead oxide in a variety of manufacturing processes. For example, according to one exemplary embodiment, calcium may be used in conjunction with a Barton process of lead oxide production. According to another exemplary embodiment, calcium may be used in processes such as solid state milling or other processes used to form lead oxide for use in lead-acid batteries.

It is also important to note that the lead oxide and manufacturing method described with regard to the exemplary embodiments is illustrative only. Although only a few embodiments of the present inventions have been described in detail in this disclosure, those skilled in the art who review this disclosure will readily appreciate that many modifications are possible without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to other exemplary embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the scope of the present inventions as expressed in the appended claims.

What is claimed is:

1. A method of producing lead oxide for use with lead-acid batteries comprising:
providing a material comprising lead;
adding calcium to the material at a level between approximately 100 and 400 ppm to form a lead-calcium alloy; and
oxidizing the lead-calcium alloy to form lead oxide.

2. The method of claim 1 wherein the material comprising lead further comprises silver.

3. The method of claim 2 wherein the silver is included in the material at a level of between approximately 0 and 100 ppm.

4. The method of claim 1 wherein the material comprises recycled lead.

5. The method of claim 4 wherein the step of adding calcium to the material comprises adding calcium to the material at a level of approximately 150 ppm.

6. The method of claim 1 wherein the step of adding calcium to the material comprises adding an ingot comprising approximately 1 atomic percent calcium to the material comprising lead.

7. The method of claim 1 wherein the step of oxidizing the lead-calcium alloy comprises utilizing a Barton process.

8. The method of claim 1 wherein the step of oxidizing the lead-calcium alloy comprises utilizing a solid state milling process.

9. The method of claim 1 wherein the step of adding calcium comprises adding at least one of metallic calcium and an intermetallic lead-calcium alloy.

10. A method for making lead oxide for use in lead-acid battery active material comprising:
oxidizing a material comprising lead, calcium, and silver to form lead oxide, wherein the calcium is present in the material in an amount between approximately 100 and 400 ppm.

11. The method of claim 10 wherein the material comprises between approximately 0 and 100 ppm silver.

12. The method of claim 10 wherein at least a portion of the lead is recycled lead.

13. The method of claim 10 wherein the step of oxidizing the material comprises utilizing a solid state milling technique.

14. The method of claim 10 wherein the step of oxidizing the material comprises providing the material in a Barton pot and reacting the material with oxygen.

15. The method of claim 10 wherein the calcium is present in the material at a level of approximately 150 ppm.

16. A method for preparing electrodes for use in a lead-acid battery comprising:
preparing a material comprising lead and between approximately 100 and 400 ppm calcium;
oxidizing the material to form lead oxide; and
mixing the oxidized material with water and acid to produce a paste.

17. The method of claim 16 further comprising applying the paste to a battery electrode.

18. The method of claim 17 further comprising curing the paste on the battery electrode.

19. The method of claim 16 wherein the material comprising lead further comprises silver at a level of between approximately 0 and 100 ppm.

20. The method of claim 16 wherein the step of oxidizing the material comprises introducing the material into a Barton pot and reacting the material with oxygen to form lead oxide.

21. The method of claim 16 wherein the material comprising lead comprises approximately 150 ppm calcium.

22. A method of enhancing the oxidation of lead during production of lead-acid batteries comprising alloying between about 100 and 400 ppm calcium with the lead and subjecting the resulting alloy to oxidizing conditions.

23. The method of claim 22 wherein the lead contains silver.

24. The method of claim 22 wherein the lead is recycled lead.

25. The method of claim 22 wherein the step of alloying between about 100 and 400 ppm calcium comprises alloying approximately 150 ppm calcium with the lead.

26. The method of claim 22 wherein the lead oxidation is effected in a pot reactor.

27. The method of claim 22 wherein the lead oxidation is effected in a ball mill.

28. In a method of oxidizing lead used in production of lead-acid batteries, the improvement comprising effecting oxidation after alloying between approximately 100 and 400 ppm calcium into the lead.

29. The method of claim 28 wherein the calcium content is approximately 150 ppm.

30. The method of claim 28 wherein the lead oxidation is effected in a pot reactor.

31. The method of claim 28 wherein the lead oxidation is effected in a ball mill.

32. A method of producing lead oxide from lead alloys containing silver for use in a lead acid battery electrode comprising alloying calcium into the silver-containing lead and subjecting the resultant alloy to oxidizing conditions.

33. The method of claim 28 wherein the calcium content of the alloy is between approximately 100 and 400 ppm.

34. The method of claim 28 wherein the calcium content of the alloy is approximately 150 ppm.

35. The method of claim 28 wherein the silver content of the lead is between approximately 0 and 100 ppm.
